(19) United States
(12) Patent Application Publication
(10) Pub. No.: US 2008/0180211 A1
(43) Pub. Date: Jul. 31, 2008

(54) ELECTRICITY-SAVING TYPE INFRARED ELECTRONIC LOCK CORE

(76) Inventor: Chin-Min Lien, Taichung City (TW)

Correspondence Address: RABIN & Berdo, PC, 1101 14TH STREET, NW, SUITE 500, WASHINGTON, DC, 20005, US

(21) Appl. No.: 11/669,282

(22) Filed: Jan. 31, 2007

(51) Int. Cl. G06F 7/00

(52) U.S. Cl. 340/5.61

(57) ABSTRACT

An electricity-saving type infrared electronic lock core is disclosed herein, which includes a body, an infrared sensor, a radio frequency identification system and a power supplier. The infrared sensor is disposed on one end of the body and includes an infrared receiver-transmitter, and the radio frequency identification system is electrically connected with the infrared sensor, the power supplier and the relative elements for unlocking the body. When the infrared sensor detects a person or an object within the scheduled area, the radio frequency identification system can identify it and further drive the relative elements for unlocking the body if the identification is correct. But when the infrared sensor does not detect a person or an object, the radio frequency identification system enters into an electricity-saving mode for saving the electric power.

### BACKGROUND OF THE INVENTION

1. Field of the Invention

The present invention relates to an electronic lock core structure, especially to an electricity-saving type infrared electronic lock core combined with a radio frequency identification system and an infrared sensor for controlling the startup of an identifying device so as to attain the objective of saving electric power.

2. The Prior Arts

Nowadays, locks have been developed much quickly and the type of the locks is diversified. The structures of all the conventional mechanical locks are to make use of the lock bolt in the lock core and the special key having concave grooves and convex faces corresponding to the lock bolt and further to make the lock bolt in the concave groove of the key to move to the prearranged position, thus the lock bore can be turned or moved axially so as to achieve security objective. But this kind mechanical lock only has one simple locking function and it can be easily unlocked by making use of proper tools. Furthermore, the key of the mechanical lock can be copied easily and the protective function is not perfect.

The radio frequency identification system can transmit and receive the unique recognition data in tags by making use of the radiofrequency signals in wireless way. When the system is startup, a reader can produce a certain frequency radio signal to start up the program on a chip in a tag, and then generate a radio frequency electric wave, and transmit the identification code in the memory of the chip or other stored information to the reader. After the identification code or the stored information is decoded, the identification and the decoding are completed. The system has many advantages of, such as a convenient use because it can directly identify an object, and a high safety because an authorized identification code can not be copied easily. And the card or the tag does not need to be applied an outer electrical source, so it has been widely used in daily life. But in order to keep the reader produce one certain frequency radio signal continually for detecting the card or the tag at any moment, the power should be provided continually to the reader to keep it in stand-by state and thus much electric power would be wasted. Especially for the electronic lock which uses batteries as the electric source, it wastes more electric power. So, if a radio frequency identification system is positioned on a lock core and further combined with a sensor system and the radio frequency identification system, by means of firstly detecting a person or an object entering into the sensing area and then starting up the reader, the system can save the electric power and the lock safety can be further improved.

### SUMMARY OF THE INVENTION

In order to solve the disadvantage of wasting electric power because the radio frequency identification system disposed on the electronic lock has to be in stand-by state continually, the present invention provides an electricity-saving type infrared electronic lock core combined with an infrared sensor. By making use of the detection of the infrared sensor, only when the person or the object comes into the sensing area, the radio frequency identification system in the electronic lock core can be started up to identify it so as to unlock the lock. Therefore, saving electric power and improving security can be achieved.

In order to achieve above invention objective, the present invention provides an electricity-saving type infrared electronic lock core which comprises a body, an infrared sensor, a radio frequency identification system and a power supplier. The infrared sensor positioned on one end of the body, comprises an infrared receiver-transmitter. The radio frequency identification system positioned on one end of the infrared receiver-transmitter can be electrically connected with the infrared sensor, the power supplier and relative elements for unlocking the body. When the infrared receiver-transmitter on the infrared sensor detects a person or an object in the scheduled area, the radio frequency identification system can identify it and drive the relative elements to unlock the body if the identification is correct. When the infrared sensor does not detect a person or an object, the radio frequency identification system can not be started up. Therefore, the identifying device does not need to transmit frequency signal constantly and thus the electric power can be saved.

The electricity-saving type infrared electronic lock core according to the present invention, not only has a high safety and guarding function against theft because of the special high security identification code of the radio frequency identification system, but can save the electric power consuming on standby by means of an infrared sensor on which an infrared receiver-transmitter is positioned to start up an identifying device, only when a person or an object is detected.

Reference will now be made in detail to embodiments of the present invention, examples of which are illustrated in the accompanying drawings. Although the present invention has been described with reference to the preferred embodiment thereof, it is apparent to those skilled in the art that a variety of modifications and changes may be made without departing from the scope of the present invention which is intended to be defined by the appended claims.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded perspective view of an electricity-saving type infrared electronic lock core according to an embodiment of the present invention,;

FIG. 2 is a perspective view of the electricity-saving type infrared electronic lock core according to the embodiment of the present invention,;

FIG. 3 is a cross-sectional schematic view showing a front clutch and a back clutch unconnected with each other before unlocking the electronic lock, according to the present invention; and

FIG. 4 is a cross-sectional schematic view showing the front clutch and the back clutch connected together after unlocking the electronic lock, according to the present invention.

### DETAILED DESCRIPTION OF THE PREFERRED EMBODIMENT

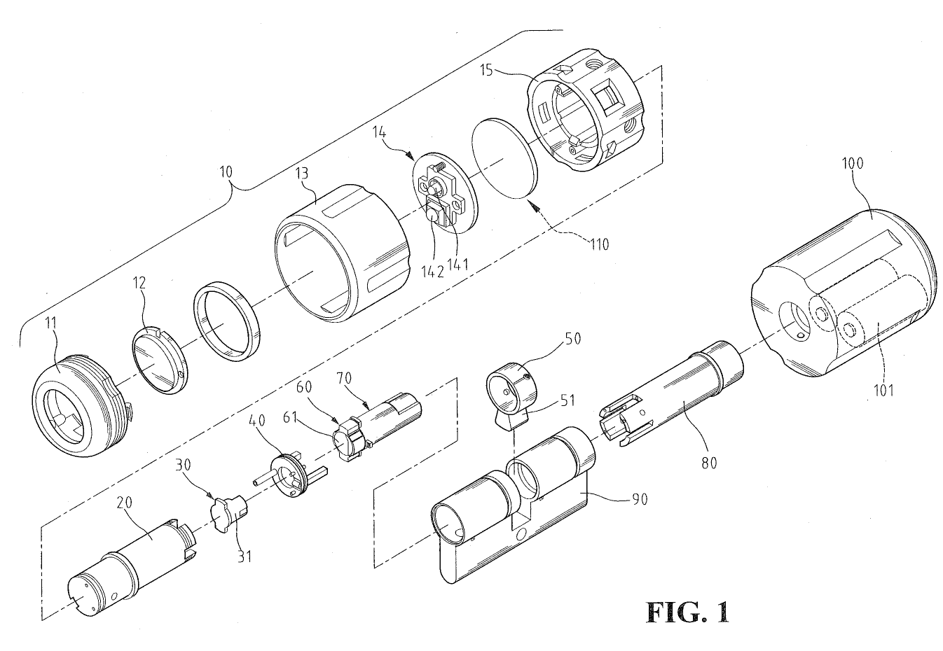

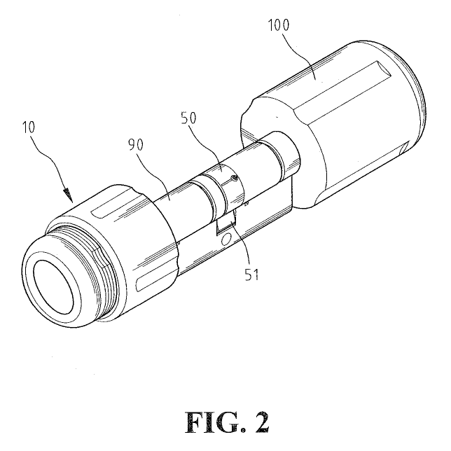

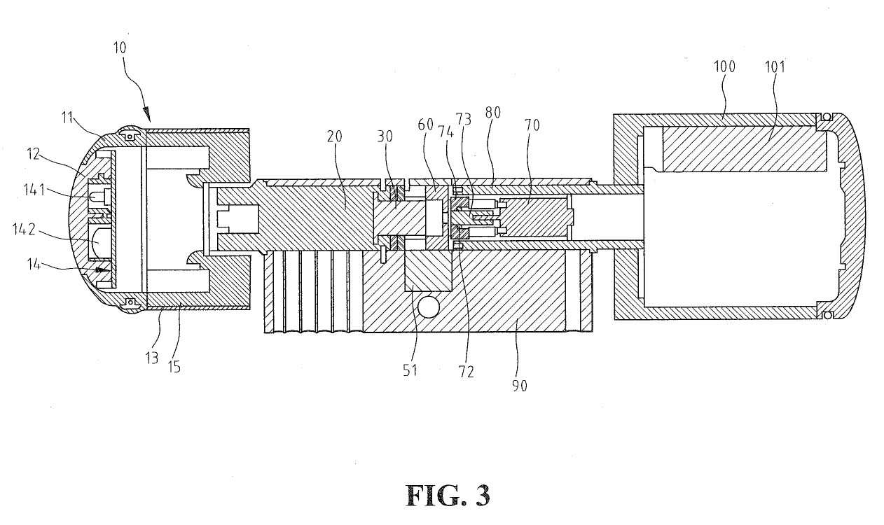

With reference to FIGS. 1-3, which respectively show an exploded perspective view, a perspective view and a cross-sectional view of an electricity-saving type infrared electronic lock core in accordance with an embodiment of the present invention, the electricity-saving type infrared electronic lock core comprises an infrared sensor 10, a body 20, a front clutch member 30, a back clutch member 60, a motor section 70, a knob core 80 and a radio frequency identification system 110. The infrared sensor 10 is electrically connected with the radio frequency identification system 110 and one end of the body 20 is connected with the infrared sensor 10 and the other end is contacted with the front clutch member 30. In addition, one end of the motor section 70 is connected with the back clutch member 60 which can be assembled with the front clutch member 30 and the other end of the motor section 70 is connected with the knob core 80. Other more, the radio frequency identification system 110 can drive the motor section 70 to drive relative elements so as to unlock the lock. Therefore when a person or an object in the sensing area, the infrared sensor 10 can detect it and start up the radio frequency identification system 110 to identify it. Once the identification information is confirmed to be correct, the motor section 70 can be further driven to push the back clutch member 60 to move forward and engage with the front clutch member 30 and in the meantime the body 20 and the knob core 80 can be turned at the same time, other more the turned knob core 80 can drive a cam 50 to unlock the lock. But when no any person or object is in the sensing area, the radio frequency identification system 110 can not be started up and it will not transmit the radio frequency signal constantly so as to achieve the objective of saving electric power.

The infrared sensor 10 connected on one end of the body 20, comprises an infrared receiver-transmitter 14 one end of which is connected with the radio frequency identification system 110 and the radio frequency identification system 110 is electrically connected with the infrared sensor 10. The infrared receiver-transmitter 14 is positioned in a containing section 15 and is covered with a light-transmitting shade 12 which can keep the humidity from coming in the electronic lock so as to guarantee the infrared receiver-transmitter 14 and other electronic elements to work in order and make the infrared ray penetrate through the electronic lock to detect the objects. The whole infrared sensor 10 is positioned in a housing 13, on one end of which a cover 11 is covered, and the cover 11 which the light-transmitting shade 12 is positioned therein is hollow, so that the light-transmitting shade 12 can be positioned here firmly. In addition, the infrared receiver-transmitter 14 is composed of a transmitter 141 and a receiver 142, and the transmitter 141 can transmit an infrared ray to detect any person or object in the sensing area. When a person or an object is detected, the infrared ray is reflected back to the receiver 142 and then the receiver 142 further starts up the radio frequency identification system 110 to identify it. Only once the identification information is confirmed to be correct, the electronic lock can be unlocked. After the electronic lock is unlocked about 5 seconds or nothing is detected in the inducing area, the infrared sensor 10 can control the radio frequency identification system to be in battery saving mode so that the radio frequency identification system 110 does not transmit frequency signal constantly and the electric power is saved. On the other hand, the infrared sensor 10 can adjust the transmitting frequency of detecting, so even if in low energy consuming condition the detecting function still can be kept and the needed electric power is saved.

One end of the body 20 is connected with the infrared sensor 10 and the other end is contacted with the front clutch member 30. After the identification information is confirmed to be correct and the relative elements are driven to make the back clutch member 60 and the front clutch member 30 to be engaged together, turn the body 20 and the knob core 80 at the same time. Thus the electronic lock can be unlocked.

The front clutch member 30 is contacted with the other end of the body 20 and the other end of the front clutch member 30 is formed with a shaft section 31 which is provided to make the front clutch member 30 and the back clutch member 60 to be connected together.

The back clutch member 60 is coupled with the motor section 70 and can be moved backward and forward. When the back clutch member 60 is moved forward, it can be connected with the front clutch member 30 and then the body 20 can be turned, thus the lock can be unlocked.

Other more, the motor section 70 is electrically connected with the radio frequency identification system 110. By means of the driven of the radio frequency identification system 110, the motor section 70 can start up the relative elements of the body 20 in sequence. Besides, one end of the motor section 70 is connected with a knob core 80 and the other end is connected with a screw 73 engaged with a screw cap 72, which is clipped and embedded in a cover body 74. But because the cover body 74 is limited to move, the cover body 74 and the screw cap 72 can not rotate following with the screw 73. Therefore, as the motor section 70 drives the screw 73 to rotate, it can drive the screw cap 72 and the cover body 74 to slide forward but not to rotate in original position so as to push the back clutch member 60. When the radio frequency identification system 110 confirms the identifying information to be correct, it can transmit signal to the motor section 70 so as to further run it and make it drive and push the relative elements to unlock the body 20. Furthermore, a connecting hole 61 is formed on the back clutch member 60 and is provided to contain the shaft section 31 of the front clutch member 30 as the back clutch member 60 is driven to move forward by the motor section 70, thus the back clutch member 60 can be connected with the front clutch member 30. Besides, between the back clutch member 60 and the front clutch member 30 a conducting component 40 is positioned for electrically connecting the two members.

Except for the infrared sensor 10 and the radio frequency identification system 110, all the above members are mounted in a housing 90 which can be connected with a knob 100 by means of one end of the knob core 80. A power supplier 101 is positioned in the knob 100 and in the embodiment the power supplier 101 is a battery which can be electrically connected with the radio frequency identification system 110 and provide electric power to the electronic apparatus in the body 20. Other more, a gap is formed on the housing 90 to contain a cam 50 that is connected firmly with the knob core 80 and on which a shifting block 51 is formed, so when turning the body 20 and the knob core 80, it can drive the cam 50 and the shifting block 51 so as to unlock the lock.

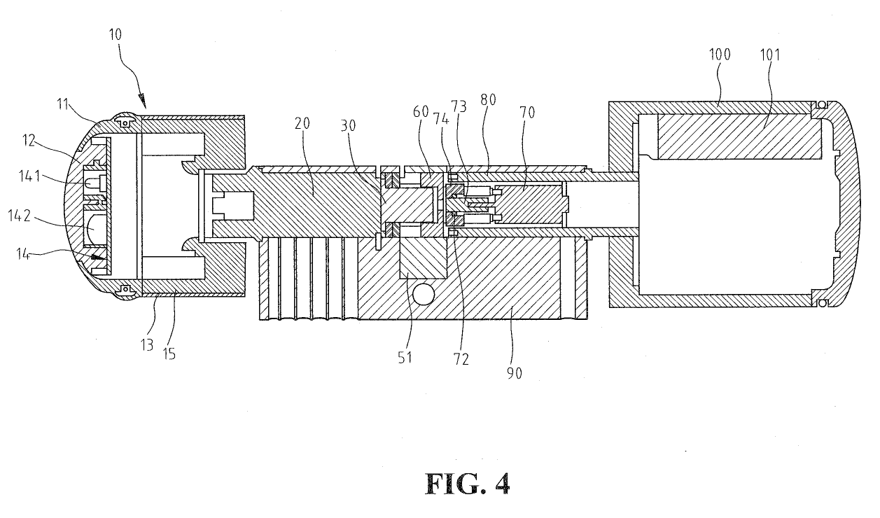

With reference to FIG. 4, which shows a cross-sectional view of an electricity-saving type infrared electronic lock core in accordance with an embodiment of the present invention, the transmitter 141 can transmit infrared ray that can be reflected back to the receiver 142 by the person or the object in the sensing area and then the receiver 142 can further start up the radio frequency identification system 110 (see FIG. 1) to identify identification information or other stored information possessed by the person or object. If the identification result is correct, the radio frequency identification system 110 (see FIG. 1) would transmit signals to the motor section 70 and start up it according to the preset program and drive the screw 73 connected with the motor section 70 to rotate and then drive the screw cap 72 and the cover body 74 to slide forward to a certain distance, so the back clutch member 60 is driven to move forward and the connecting hole 61 (see FIG. 1) of the back clutch member 60 is driven to connect with the shaft section 31 (see FIG. 1) of the front clutch member 30. At the same time to rotate the body 20 and the knob core 80 which can drive the shifting block 51 of the cam 50 to rotate so as to unlock the lock. On the other hand, when the infrared sensor does not detect any person or object, the radio frequency identification system 110 (see FIG. 1) will not start up and not transmit frequency signal constantly so as to be able to save the electric power.

What is claimed is:

1. An electricity-saving type infrared electronic lock core, comprising:
a body;
an infrared sensor connected on one end of the body and including an infrared receiver-transmitter;
an identifying device electrically connected with the infrared sensor and started up by receiving signals from the infrared sensor and electrically connected with the body for further unlocking; and
a power supplier electrically connected with the identifying device.

2. The electricity-saving type infrared electronic lock core as claimed in claim 1, wherein the identifying device is a radio frequency identification system.

3. The electricity-saving type infrared electronic lock core as claimed in claim 1, wherein the power supplier is a dry battery.

4. The electricity-saving type infrared electronic lock core as claimed in claim 1, wherein the infrared receiver-transmitter has a light-transmitting shade.

5. The electricity-saving type infrared electronic lock core as claimed in claim 1, wherein the infrared receiver-transmitter is accommodated in a containing section that is covered by a housing and one end face of the housing is covered by a hollow outer cover.

6. The electricity-saving type infrared electronic lock core as claimed in claim 4, wherein the infrared receiver-transmitter is accommodated in a containing section that is covered by a housing and one end face of the housing is covered by a hollow outer cover.
